(19) United States
(12) Patent Application Publication
(10) Pub. No.: US 2025/0392956 A1
(43) Pub. Date: Dec. 25, 2025

(54) MULTI-STREAM FAST LINK ADAPTATION (FLA) FEEDBACK

(71) Applicant: QUALCOMM Incorporated, San Diego, CA (US)

(72) Inventors: Sameer VERMANI, San Diego, CA (US); Raj Kumar KRISHNA KUMAR, Bangalore (IN); Amol SAXENA, Bangalore (IN); Shameem Ahamed IBRAHIM, Tenkasi (IN); Aditi Rajeev JAIN, Bangalore (IN); Manikandan CHANDRASEKAR, Bangalore (IN)

(21) Appl. No.: 18/749,290

(22) Filed: Jun. 20, 2024

(51) Int. Cl. H04W 28/06

(52) U.S. Cl. CPC H04W 28/065; H04L 1/0009; H04W 28/06

(57) ABSTRACT

This disclosure provides methods, components, devices and systems for multi-stream fast link adaptation (FLA) feedback. Some aspects more specifically relate to mapping a proposed quantity of spatial streams to columns of a channel matrix. According to the mapping, a channel matrix may be of a nested structure, such that a proposed quantity of spatial streams may correspond to a sequentially first and contiguous quantity of columns of the channel matrix. For example, a device may utilize a first N columns of the channel matrix to generate N spatial streams for future communications. The device may request that another device determine the proposed quantity of spatial streams and one or more corresponding FLA parameter values by transmitting an FLA request that indicates a first quantity of spatial streams and a quantity of extra spatial streams available for use.

### TECHNICAL FIELD

This disclosure relates generally to wireless communication and, more specifically, to multi-stream fast link adaptation (FLA) feedback.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a wireless device (such as a wireless communications device) is described. The method may include transmitting a first packet including one or more of a preamble and a data portion, the preamble including a LTF, the first packet including a request for one or more proposed FLA parameter values, and the data portion being associated with a first quantity of one or more spatial streams, receiving, in accordance with the request, a second packet indicating the one or more proposed FLA parameter values, the one or more proposed FLA parameter values associated with a second quantity of one or more spatial streams in accordance with a mapping of the second quantity of one or more spatial streams to a portion of the LTF of the preamble of the first packet, and transmitting a third packet in accordance with the one or more proposed FLA parameter values.

Another innovative aspect of the subject matter described in this disclosure can be implemented in a wireless device for wireless communications. The wireless device may include a processing system that includes processor circuitry and memory circuitry that stores code. The processing system may be configured to cause the wireless device to transmit a first packet including one or more of a preamble and a data portion, the preamble including a LTF, the first packet including a request for one or more proposed FLA parameter values, and the data portion being associated with a first quantity of one or more spatial streams, receive, in accordance with the request, a second packet indicating the one or more proposed FLA parameter values, the one or more proposed FLA parameter values associated with a second quantity of one or more spatial streams in accordance with a mapping of the second quantity of one or more spatial streams to a portion of the LTF of the preamble of the first packet, and transmit a third packet in accordance with the one or more proposed FLA parameter values.

Another innovative aspect of the subject matter described in this disclosure can be implemented in another wireless device for wireless communications. The wireless device may include means for transmitting a first packet including one or more of a preamble and a data portion, the preamble including a LTF, the first packet including a request for one or more proposed FLA parameter values, and the data portion being associated with a first quantity of one or more spatial streams, means for receiving, in accordance with the request, a second packet indicating the one or more proposed FLA parameter values, the one or more proposed FLA parameter values associated with a second quantity of one or more spatial streams in accordance with a mapping of the second quantity of one or more spatial streams to a portion of the LTF of the preamble of the first packet, and means for transmitting a third packet in accordance with the one or more proposed FLA parameter values.

Another innovative aspect of the subject matter described in this disclosure can be implemented in a non-transitory computer-readable medium storing code for wireless communications. The code may include instructions executable by one or more processors to transmit a first packet including one or more of a preamble and a data portion, the preamble including a LTF, the first packet including a request for one or more proposed FLA parameter values, and the data portion being associated with a first quantity of one or more spatial streams, receive, in accordance with the request, a second packet indicating the one or more proposed FLA parameter values, the one or more proposed FLA parameter values associated with a second quantity of one or more spatial streams in accordance with a mapping of the second quantity of one or more spatial streams to a portion of the LTF of the preamble of the first packet, and transmit a third packet in accordance with the one or more proposed FLA parameter values.

In some examples of the method, wireless devices, and non-transitory computer-readable medium described herein, transmitting the first packet may include operations, features, means, or instructions for transmitting an indication of one or more extra spatial streams associated with the LTF of the preamble of the first packet, where the one or more extra spatial streams include spatial streams associated with the LTF that may be in excess of the first quantity of one or more spatial streams.

In some examples of the method, wireless devices, and non-transitory computer-readable medium described herein, receiving the one or more proposed FLA parameter values may include operations, features, means, or instructions for receiving one or more proposed MCS indices associated with the second quantity of one or more spatial streams, where the one or more proposed MCS indices may be associated with one or more columns of a channel matrix in accordance with the mapping of the second quantity of one or more spatial streams to the portion of the LTF.

In some examples of the method, wireless devices, and non-transitory computer-readable medium described herein, the mapping of the second quantity of one or more spatial streams to the portion of the LTF may be defined in accordance with the one or more proposed MCS indices being mapped to an equal quantity of sequentially first contiguous columns of the channel matrix.

Details of one or more implementations of the subject matter described in this disclosure are set forth in the accompanying drawings and the description below. Other features, aspects, and advantages will become apparent from the description, the drawings and the claims. Note that the relative dimensions of the following Figures may not be drawn to scale.

### BRIEF DESCRIPTION OF THE DRAWINGS

FIG. 1 shows a pictorial diagram of an example wireless communication network, where one or more entities communicate fast link adaptation (FLA) feedback.

FIG. 2 shows an example physical layer (PHY) protocol data unit (PPDU) usable for communications between a wireless access point (AP) and one or more wireless stations (STAs) or between two or more STAs, where the PPDU may carry an FLA request.

FIG. 3 shows a hierarchical format of an example PPDU usable for communications between a wireless AP and one or more wireless STAs or between two or more STAs, where the example PPDU may include an FLA request.

FIG. 4 shows an example of a PPDU that supports multi-stream fast link adaptation (FLA) feedback, where the PPDU may include additional long training fields (LTFs) and an indication of additional spatial streams for measurement and FLA reporting.

FIG. 5 shows an example of a process flow that supports multi-stream FLA feedback, where an AP may communicate a packet with a STA using a quantity of spatial streams in accordance with FLA feedback.

FIG. 6 shows a block diagram of an example wireless communication device that supports multi-stream FLA feedback, where the wireless device may include an FLA request component and an FLA feedback component for FLA feedback communication.

FIG. 7 shows a flowchart illustrating an example process performable by or at an access point (AP) that supports multi-stream FLA feedback.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a first wireless device (such as a wireless access point (AP), a wireless station (STA), a transmitting wireless device) may communicate via a wireless channel (such as a wireless link) that may include one or more spatial streams. In some examples, the first wireless device may transmit a fast link adaptation (FLA) request to request FLA feedback from a second wireless device (such as a receiving wireless device). In some examples, the FLA feedback may indicate to the first wireless device one or more proposed FLA parameter values (such as one or more MCS indices) to improve channel quality for future communications. The second wireless device may determine the proposed FLA parameter values according to measurements of one or more long training fields (LTFs) in a preamble of packet carrying the FLA request.

Indicating a proposed quantity of spatial streams to the first wireless device may allow the first wireless device to set a quantity of spatial streams that efficiently accommodates the expected channel use between the first wireless device and the second wireless device. Nevertheless, when the proposed quantity of spatial streams is less than the quantity of spatial streams associated with the LTFs that the second wireless device measures to provide the FLA feedback, the FLA feedback may be unclear about which columns of the channel matrix associated with the LTFs apply to the FLA feedback. If the first wireless device is unable to resolve this ambiguity, the first wireless device may incorrectly map FLA parameters to a spatial stream that was not intended by the second wireless device, resulting in suboptimal communications between the wireless devices.

Various aspects relate generally to communication of multi-stream FLA feedback. Some aspects more specifically relate to defining a mapping between a proposed quantity of spatial streams and one or more entries (such as one or more columns, one or more rows) of one or more spatial mapping matrices (such as spatial mapping matrices associated with transmission or reception of one or more training fields, such as LTFs). In some examples, a second wireless device may transmit FLA feedback to a first wireless device indicating a proposed quantity of spatial streams and one or more proposed FLA parameter values for communicating via the proposed quantity of spatial streams. According to the mapping, a spatial mapping matrix associated with communications between the first device and the second device (such as a precoding matrix, a channel matrix) may be of a nested structure, such that the proposed quantity of spatial streams (also referred to herein as a second quantity of spatial streams) may correspond to a sequentially first and contiguous quantity (such as a left-most quantity) of columns (or rows) of the spatial mapping matrix. For example, the proposed quantity of spatial streams may include N spatial streams, where N may be a different quantity than a quantity of spatial streams used to transmit a portion of the FLA request (such as an LTF in the preamble of the FLA request). The first device may utilize a first N columns of a channel matrix (such as the left-most N columns) to generate N spatial stream for future communications. In some examples, the first device may request that the second device determine the proposed quantity of spatial streams and one or more corresponding FLA parameter values. For example, the first device may transmit an FLA request that indicates a first quantity of spatial streams (such as a quantity of spatial streams used to communicate the data portion of the FLA request) and a quantity of extra spatial streams (such as additional spatial streams used to transmit one or more long training fields (LTFs) of the FLA request). The second device may determine the proposed quantity of spatial streams to be less than or equal to a sum of the first quantity of spatial streams and the quantity of extra spatial streams.

Particular aspects of the subject matter described in this disclosure can be implemented to realize one or more of the following potential advantages. In some examples, by implementing the mapping of spatial streams to the columns (or rows) of the matrices (such as the channel matrix, the P matrix, the spatial mapping matrix), wireless devices may communicate and implement FLA feedback with reduced ambiguity. Although the mapping may be referred to as a mapping between spatial streams and columns of a matrix, the mapping also may be between spatial streams and rows of a matrix (such as the terms “column” and “row” may be interchangeable, such as in the example of mapping the spatial streams to the rows of the P matrix). Reduced ambiguity may reduce wireless communication errors (such as applying proposed FLA parameters to the wrong spatial stream) and thus increase wireless communication efficacy. This reduction in ambiguity may improve the efficiency of the FLA feedback and spatial adaptation process, which may lead to increased communications throughput, reduced latency in the spatial adaptation process, improved user experience, improved power efficiency, and improved spectral efficiency.

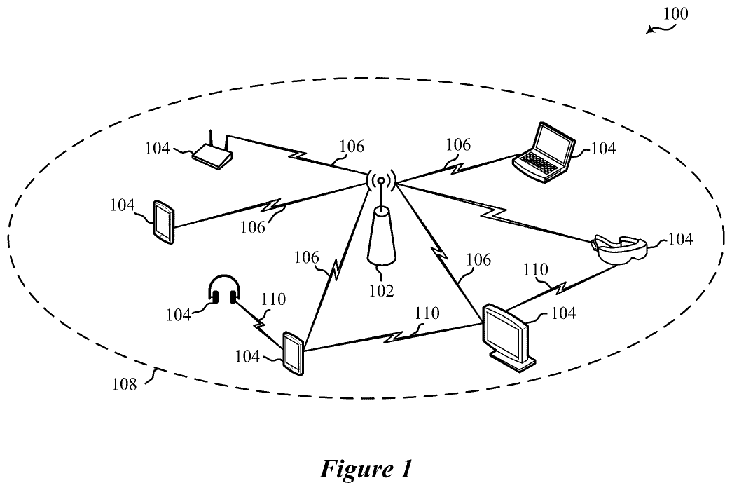

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

APs and STAs (such as the AP 102 and the STAs 104 described with reference to FIG. 1) that include multiple antennas may support various diversity schemes. For example, spatial diversity may be used by one or both of a transmitting device (such as either AP 102 or STA 104) or a receiving device (such as either AP 102 or STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_Tx of transmit antennas exceeds the number N_SS of spatial streams. The N_SS spatial streams may be mapped to a number N_STS of space-time streams, which are then mapped to N_Tx transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_SS of separate, independent spatial streams. The spatial streams are then separately encoded and transmitted in parallel via the multiple N_Tx transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally or alternatively involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may then perform measurements for each of the N_Tx×N_Rx sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may then generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, power level, etc. to use to transmit a respective signal on each of the beamformer's antennas.

When performing beamforming, the transmitting beamforming array gain is logarithmically proportional to the ratio of N_Tx to N_SS. As such, it is generally desirable, within other constraints, to increase the number N_Tx of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

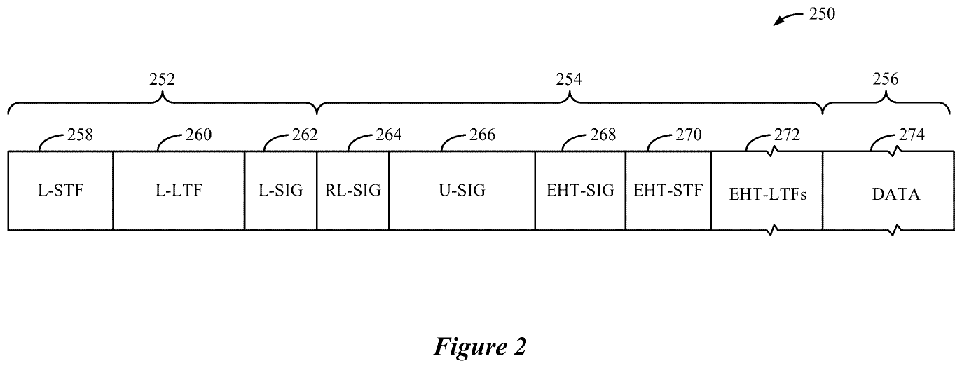

FIG. 2 shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264 and multiple wireless communication protocol version-dependent signal fields after RL-SIG 264. For example, the non-legacy portion 254 may include a universal signal field 266 (referred to herein as “U-SIG 266”) and an EHT signal field 268 (referred to herein as “EHT-SIG 268”). The presence of RL-SIG 264 and U-SIG 266 may indicate to EHT- or later version-compliant STAs 104 that the PPDU 250 is an EHT PPDU or a PPDU conforming to any later (post-EHT) version of a new wireless communication protocol conforming to a future IEEE 802.11 wireless communication protocol standard. One or both of U-SIG 266 and EHT-SIG 268 may be structured as, and carry version-dependent information for, other wireless communication protocol versions associated with amendments to the IEEE family of standards beyond EHT. For example, U-SIG 266 may be used by a receiving device (such as the AP 102 or the STA 104) to interpret bits in one or more of EHT-SIG 268 or the data field 274. Like L-STF 258, L-LTF 260, and L-SIG 262, the information in U-SIG 266 and EHT-SIG 268 may be duplicated and transmitted in each of the component 20 MHz channels in instances involving the use of a bonded channel.

The non-legacy portion 254 further includes an additional short training field 270 (referred to herein as “EHT-STF 270,” although it may be structured as, and carry version-dependent information for, other wireless communication protocol versions beyond EHT) and one or more additional long training fields 272 (referred to herein as “EHT-LTFs 272,” although they may be structured as, and carry version-dependent information for, other wireless communication protocol versions beyond EHT). EHT-STF 270 may be used for timing and frequency tracking and AGC, and EHT-LTF 272 may be used for more refined channel estimation.

EHT-SIG 268 may be used by an AP 102 to identify and inform one or multiple STAs 104 that the AP 102 has scheduled uplink (UL) or downlink (DL) resources for them. EHT-SIG 268 may be decoded by each compatible STA 104 served by the AP 102. EHT-SIG 268 may generally be used by the receiving device to interpret bits in the data field 274. For example, EHT-SIG 268 may include resource unit (RU) allocation information, spatial stream configuration information, and per-user (such as STA-specific) signaling information. Each EHT-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

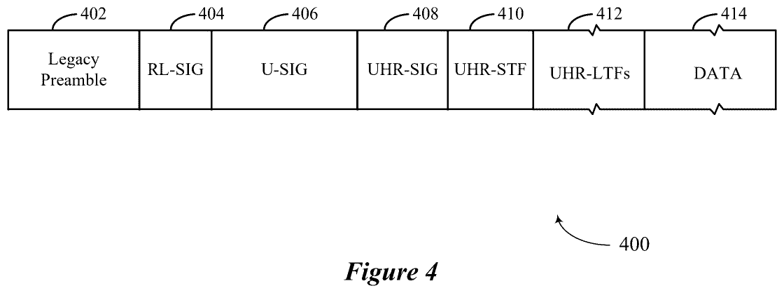

In some examples, a transmitting wireless device (such as an AP 102 or a STA 104) may transmit an FLA request via a PPDU (such as the PPDU 250 or a PPDU 400 as described with respect to FIG. 4). The transmitting wireless device may transmit the PPDU using a quantity of spatial streams, and may request that the receiving wireless device (such as an AP 102, a STA 104) provide FLA feedback (such as an FLA element) indicating one or more proposed FLA parameter values for subsequent communications. The proposed FLA parameter values may include one or more proposed modulation and coding schemes (MCS), one or more recommended QAM patterns for the recommended quantity of spatial streams, one or more per-stream SINR margins for supporting the anchor MCS, or any combination thereof. In some examples (such as in a first type of FLA request, FLA 1), the proposed FLA parameter values may be associated with the quantity of spatial streams used to communicate the FLA request. In some other examples (such as in a second type of FLA request, FLA 2), the proposed FLA parameter values may be associated with a proposed quantity of spatial streams (also referred to herein as the second quantity of spatial streams) that the receiving wireless device determines in response to the FLA request, and may include an indication of the proposed quantity of spatial streams. In some examples, the PPDU may indicate which type of FLA feedback is requested by the FLA request.

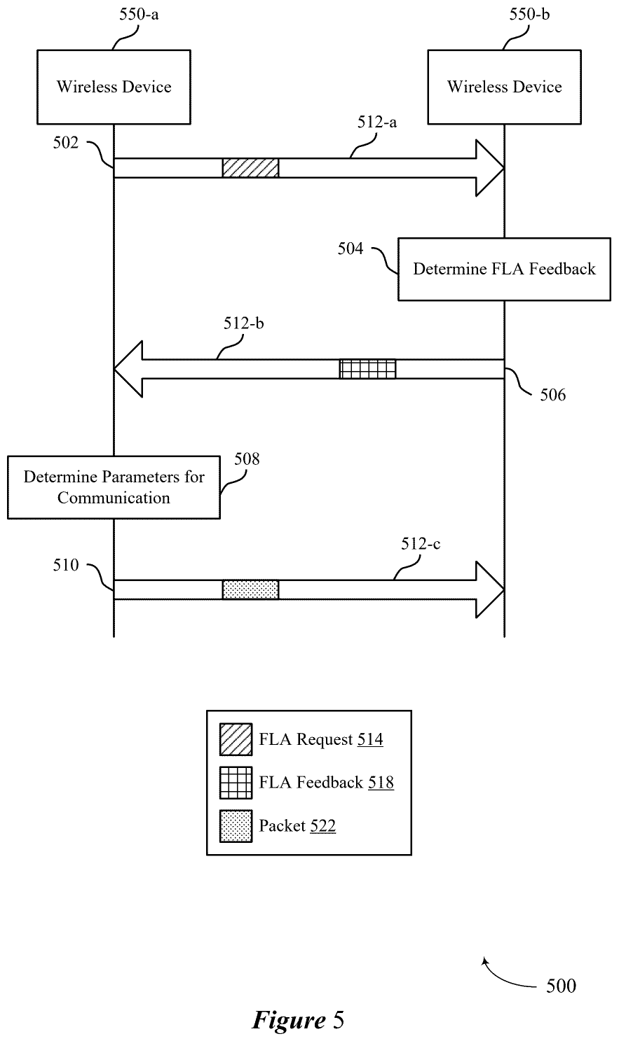

In some examples, the PPDU may include the FLA request in a field, such as an EHT-SIG 268, or an ultra-high reliability (UHR) SIG. Additionally, or alternatively, the PPDU may implicitly indicate the FLA request (such as, the structure or format of the PPDU may inherently convey the FLA request). For example, the PPDU 250 may include multiple (such as, additional) EHT-LTFs, for performing measurements and reporting additional FLA feedback (such as, if requested in the MAC header of the PPDU 250, or as inherently signaled by the existence of such EHT-LTFs). FIGS. 4 and 5 may further describe techniques for multi-stream FLA feedback with respect to the second type of FLA request.

In some examples, FLA feedback for rate adaptation (such as part of channel quality indication (CQI) estimation) may provide one or more benefits to the wireless communications system. For example, other Wi-Fi rate adaptation techniques may be relatively slow (when compared to FLA techniques) in adapting channel conditions. However, the wireless communications system may experience communication gains across multiple scenarios (such as single stream and multi-stream scenarios, scenarios without overlapping basic service sets (OBSSs), with hidden and non-hidden OBSSs, and with varying OBSS loads and burstiness) in response to implementing FLA feedback techniques.

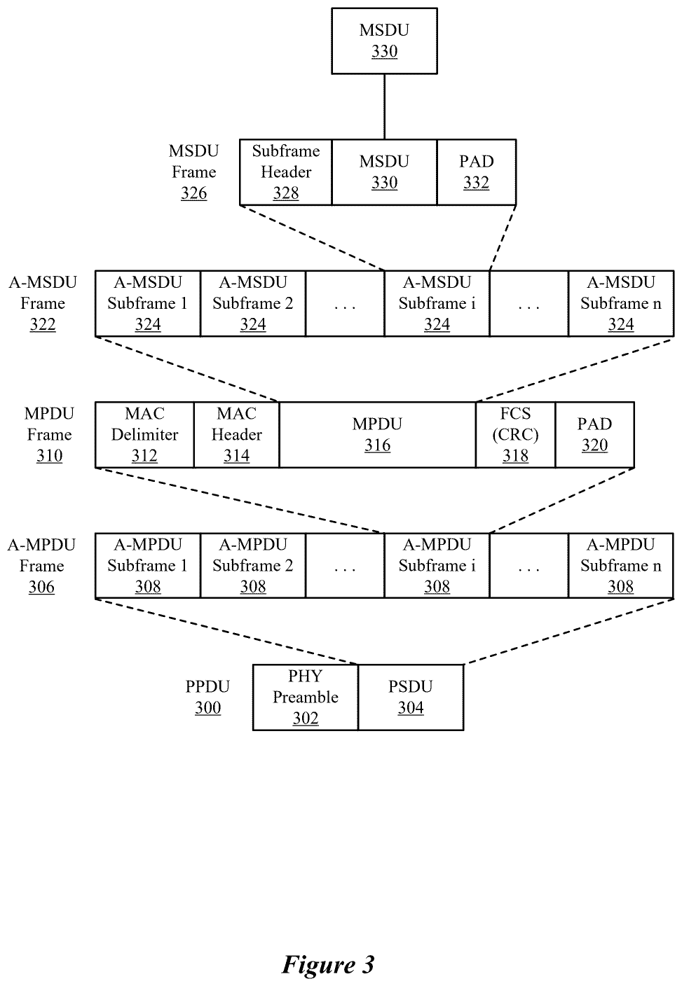

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field may include a cyclic redundancy check (CRC)) and padding bits 320. The MPDU 316 may carry one or more MAC service data units (MSDUs) 316. For example, the MPDU 316 may carry an aggregated MSDU (A-MSDU) 322 including multiple A-MSDU subframes 324. Each A-MSDU subframe 324 may be associated with (such as an example of or otherwise referred to as) an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the MPDU 316 (such as within a frame body). The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the MPDU 316 (such as within a frame body). For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

FIG. 4 shows an example of a PPDU 400 that supports multi-stream FLA feedback. The PPDU 400 may implement aspects of, or be implemented by aspects of, the example wireless communication network 100, the example PPDU 250, and the example PPDU 300. For example, at least one or more portions of the PPDU 400 may be examples of one or more portions of the PPDU 250 or the PPDU 300 as described with reference to FIGS. 2 and 3. Additionally, or alternatively, the PPDU 400 may include one or more of the fields depicted in FIG. 4. In some aspects, a transmitting wireless device (such as an AP 102, a STA 104) may transmit an FLA request via the PPDU 400, where UHR-LTFs 412 of the PPDU 400 may be associated with a different (such as larger) quantity of spatial streams as a data field 414 of the PPDU 400 to enable FLA feedback from a receiving wireless device (such as an AP 102, a STA 104) for a proposed quantity of spatial streams. As used herein, “transmitting wireless device” and “receiving wireless device” merely indicate a function of a wireless device with respect to the FLA request, and in no way limit or define the scope of functionality of the wireless device.

In some examples, the transmitting wireless device may transmit the PPDU 400, which may indicate an FLA request (such as FLA feedback request information, if the PPDU 400 is an FLA request, as described with respect to FIG. 2). The PPDU 400 may include a legacy preamble 402 (which may be an example of the PHY preamble 302), an RL-SIG 404 (which may be an example of the RL-SIG 264), an U-SIG 406 (which may be an example of the U-SIG 266), a UHR-SIG 408 (which may be an example of or similar to the EHT-SIG 268), an STF field (such as the UHR-STF 410), and one or more LTF fields (such as the UHR-LTFs 412), and the data field 414 (which may be an example of the data field 274). Additionally, or alternatively, the transmitting wireless device may transmit an FLA request in a semi-static manner, for example, through beacon signaling, capability signaling, or through occasional (such as aperiodic) custom messaging (such as signaling that is customized for an application including requesting FLA feedback).

In some examples, the transmitting wireless device may transmit at least a portion of the PPDU 400 (such as the data field 414, UHR-STF 410, both) via a first quantity of spatial streams. The first quantity of spatial streams may be the same as or less than a quantity of UHR-LTFs 412, where each of the UHR-LTFs 412 may correspond to a spatial stream of a total quantity of spatial streams that is greater than the first quantity of spatial streams. In some examples, the first quantity of spatial streams may be referred to as the number of spatial streams (Nss) (such as a quantity of spatial streams), and a quantity of spatial streams of the total spatial streams that are in excess of Nss may be referred to as the number of extra streams (Nes) (such as a quantity of extra spatial streams). That is, Nss and Nes may each be positive integers, and the sum of Nss and Nes may be equal to the total quantity of spatial streams. In some examples, the PPDU 400 may include one or more fields indicating Nss, Nes, and the quantity of UHR-LTFs 412 (such as N_LTF), which may each be indicated via separate fields.

If the PPDU 400 includes a request for FLA feedback (such as if the PPDU 400 is an FLA request), the request may be one of two or more types. In one example, the PPDU 400 may be a first type of FLA request (such as FLA 1 request), which may request one or more FLA parameter values (such as proposed FLA parameter values) for the quantity of spatial streams that the transmitting wireless device used to transmit the PPDU 400 (such as an existing transmission configuration, such as described with reference to FIG. 2). In some examples, the transmitting wireless device may transmit the first type of FLA request via one or more block acknowledgement (BA) frames (such as in a packet). The first type of FLA request may request a first type of FLA feedback (such as FLA 1 feedback), which may indicate, as part of the one or more FLA parameter values, an anchor MCS (such as an MCS indicating a spatial stream associated with the PPDU 400 that has a strongest measurement value, for the Nss and QAM pattern associated with the PPDU 400), a per-stream signal interference to noise ratio (SINR) margin for supporting the anchor MCS, or both.

In another example, the PPDU 400 may be a second type of FLA request, which may request one or more FLA parameter values (such as proposed FLA parameter values) for the recommended quantity of spatial streams, which may be different (such as larger or smaller) than Nss. In some examples, the transmitting wireless device may transmit the second type of FLA request to a receiving wireless device in a BA, or in a sounding sequence (such as when the receiving wireless device requests the sounding sequence via a nonuniform distributed power amplifier (NDPA) message). In some examples, transmitting the second type of FLA request in a sounding sequence may include transmitting a beamforming report poll frame, and may allow sufficient time for the receiving wireless device to perform FLA calculations and determine the recommended quantity of spatial streams.

The receiving wireless device may respond to the second type of FLA request with a second type of FLA feedback (such as FLA 2 feedback), which may indicate one or more FLA parameter values (such as proposed FLA parameter values). For example, the one or more FLA parameter values of the second type of FLA feedback may include an indication of the recommended quantity of spatial streams (which the receiving wireless device may determine according to measurements of the LTFs in the UHR-LTFs 412), a recommended QAM pattern for the recommended quantity of spatial streams, an anchor MCS for the recommended quantity of spatial streams, a per-stream SINR margin for supporting the anchor MCS, or any combination thereof.

In some examples, a mapping may correlate the recommended quantity of spatial streams (indicated by the FLA feedback) to a selected portion of the columns of the channel matrix used by the transmitting device to transmit the FLA request (such as the data portion of the FLA request). For example, the mapping may be known by the transmitting wireless device and the receiving wireless device (such as a standardized mapping). In some examples, the mapping may correlate the recommended (such as proposed) quantity of spatial streams with an equal quantity of sequentially first and contiguous columns of the channel matrix. For example, if the FLA feedback indicates one proposed spatial stream, the one proposed spatial stream may correspond to the first (such as left most) column of the channel matrix. Additionally, or alternatively, the mapping may apply to other matrices associated with communications between the transmitting wireless device and the receiving wireless device (such as a precoding matrix, a P matrix, a spatial mapping matrix), such that the quantity of proposed spatial streams may correlate an equal quantity of sequentially first and contiguous columns of the matrices (or rows of the matrices, such as in the example of the P matrix).

In the example of the second type of FLA request, the PPDU 400 may include an indication of the quantity of spatial streams used for transmitting the PPDU 400 (such as Nss, the quantity of spatial streams for transmitting the data field 414), an indication of Nes for determining the FLA parameter values (such as performing FLA parameter value calculations) and the recommended quantity of spatial streams, or both. For example, the UHR-LTFs 412 may include extra LTFs (such as Nes more LTFs) than may be used for decoding the data field 414. The receiving wireless device may use the extra LTFs to determine the recommended quantity of spatial streams, the anchor MCS, and other FLA parameter values of the second type of FLA feedback.

In some examples, the Nss value and the Nes value may be included in the UHR-SIG 408. For example, the indication of Nes may include a quantity of bits (such as one, two, or three bits, in a field of the PPDU 400, in the UHR-SIG 408). A combination of Nes and Nss (such as Nss+Nes) may indicate a total quantity of spatial streams associated with (such as active in) the UHR-LTFs 412. FLA calculations at the receiving wireless device may account for up to Nss+Nes spatial streams, such that the recommended quantity of spatial streams (such as in the second type of FLA feedback) may be a quantity of spatial streams that is less than or equal to Nss+Nes.

The PPDU 400 may sound the spatial streams (such as the Nss spatial streams and the Nes spatial streams) to the receiving wireless device, allowing the receiving wireless device to determine the FLA parameter values for up to Nss+Nes spatial streams. In some examples, the PPDU 400 may sound the spatial streams via a single segment in the UHR-LTF 412. For example, the transmitting wireless device of the PPDU 400 may modulate the UHR-LTFs 412 in a single segment via Nss+Nes rows of an N_LTF dimensional matrix (such as the P matrix). Additionally, or alternatively, the PPDU 400 may sound the spatial streams via two segments of the UHR-LTF 412. For example, a first segment of the UHR-LTF 412 may sound Nss streams, and a second segment of the UHR-LTF 412 may sound Nes streams. For example, the transmitting wireless device may modulate the LTFs in a first segment of the UHR-LTF 412 via the first Nss rows of a P matrix, and may modulate the LTFs of a second segment of the UHR-LTFs 412 via Nes rows of a P matrix. In some examples, Nss rows and the Nes rows may be from a same P matrix or different P matrices (such as including a P_1 matrix).

In some examples, the receiving wireless device (such as an FLA request) may calculate a channel matrix associated with a wireless channel used for communicating the PPDU 400 (such as wireless channel 512-a described with respect to FIG. 5) using the UHR-LTFs 412. Additionally, or alternatively, the receiving wireless device may use the calculated channel matrix to determine the one or more proposed FLA parameter values. For example, the receiving wireless device may use the following equation (model) for receiving signals from the transmitting wireless device:

$$y = H Q x + n .$$

In Equation 1, y may represent the signal received at the receiving wireless device (such as the received PPDU 400, received UHR-LTFs 412), x may represent the signal transmitted by the transmitting wireless device (such as the transmitted PPDU 400, the transmitted UHR-LTFs 412 according to the P matrix), and n may represent noise in the channel. H [symbol] may represent a matrix multiplication between a channel matrix H (such as a true channel matrix, an over the air wireless channel matrix) and an antenna map matrix [symbol] . In some examples, the receiving wireless device may estimate H [symbol] , and may not be capable of estimating H in isolation. Thus, H [symbol] may be known as a net channel matrix or an effective channel matrix. As used herein, the “channel matrix” may refer to H, [symbol] , H [symbol] , or any combination thereof, as determined by the receiving wireless device.

In some examples (such as if the transmitting wireless device sounds the spatial streams via a single segment of the UHR-LTFs 412), the transmitting wireless device may apply a power scaling to the PPDU 400 if the total quantity of streams associated with the UHR-LTFs 412 is different from the first quantity of streams associated with the data field 414 (such as, due to the Nes streams and extra LTFs). For example, when using the second type of FLA request, a power per spatial stream of the data field 414 of the PPDU 400 may increase (such as when compared to the first type of FLA request) by a factor of

$$\frac{Nss + Nes}{Nss} .$$

The receiving wireless device may digitally apply a power scaling of

$$\sqrt{\frac{( N s s + N e s )}{N s s}}$$

to measurements of the UHR-LTFs 412 (such as a channel estimate) before decoding the information of the data field 414. In some examples, a channel estimation quality may not decrease due to the applied power scaling due to a greater quantity of LTFs in the UHR-LTF 412 providing higher fidelity estimates. Additionally, or alternatively, power across the time domain in each of the UHR-STF 410, the UHR-LTFs 412, and the data field 414 may remain the same within an FLA request of either the first type of FLA request or the second type of FLA request.

The transmitting wireless device may beamform the transmission of the PPDU 400, which may include transmitting the UHR-LTFs 412 and the data field 414 at different power levels. For example, different amounts of beamforming gain associated with the UHR-LTFs 412 and the data field 414 may lead to different power levels for each. In some examples, the UHR-LTFs 412 may be received at slightly lower power levels (such as 3 dB less if the data field 414 is associated with 1 spatial stream and the UHR-LTFs 412 is associated with 2 spatial streams) due to less beamforming gain, which may impact an analog to digital converter dynamic range at the receiving wireless device (such as decrease the dynamic range by half of a bit).

FIG. 5 shows an example of a process flow 500 that supports multi-stream FLA feedback. In some examples, aspects of the process flow 500 may implement or be implemented by aspects of FIGS. 1-4. For example, the process flow 500 may include a wireless device 550-a and a wireless device 550-b, each of which may be an example of an AP 102, a STA 104, or another wireless device. Additionally, or alternatively, the wireless device 550-a may be an example of a transmitting wireless device described with respect to FIG. 4, and the wireless device 550-b may be an example of a receiving wireless device as described with respect to FIG. 4. In some aspects, the wireless devices 550 may exchange signaling associated with FLA feedback via wireless channels 512 (such as a wireless channel 512-a, a wireless channel 512-b, and a wireless channel 512-c), where each wireless channel 512 may include a respective quantity of spatial streams and correspond to one or more FLA parameter values. In some aspects, the wireless device 550-a may receive, via FLA feedback 518 and in response to an FLA request 514, one or more proposed FLA parameter values for communication between the wireless devices 550. Additionally, or alternatively, the wireless device 550-a may communicate with the wireless device 550-b via the wireless channel 512-c using one or more FLA parameter values and a quantity of spatial streams associated with the FLA feedback 518 and a mapping between spatial streams and columns of a channel matrix (or another matrix, such as a precoding, a P matrix, a spatial mapping matrix).

In the following description of process flow 500, the operations may be performed in a different order than the order shown, or other operations may be added or removed from the process flow 500. For example, some operations may be left out of process flow 500, may be performed in different orders or at different times, or other operations may be added to process flow 500. Although the wireless devices 550 are shown performing the operations of process flow 500, some aspects of some operations also may be performed by one or more other wireless devices or network devices.

At 502, the wireless device 550-a (such as a first wireless device, a transmitting wireless device) may transmit an FLA request 514 (such as a first packet), which may include one or more of a preamble and a data portion. In some examples, the FLA request 514 may include one or more LTFs (such as the UHR-LTFs 412, in the preamble portion) and a request for the wireless device 550-b to respond with one or more proposed FLA parameter values. In an example where the FLA request 514 includes a data portion, the data portion may be associated with (such as, transmitted via) a first quantity of one or more spatial streams. In some examples, a quantity of spatial streams associated with the LTFs of the preamble of the FLA request 514 (such as a total quantity of spatial streams associated with the LTFs, Nss+Nes as described with respect to FIG. 4) may be greater than the first quantity of one or more spatial streams.

In some examples, the FLA request 514 may include an indication of one or more extra spatial streams (such as Nes, as described with respect to FIG. 4) associated with the LTFs of the preamble of the FLA request 514. For example, the one or more extra spatial streams may include spatial streams associated with the LTFs that are in excess of the first quantity of one or more spatial streams. In some examples, the wireless device 550-a may transmit the LTFs of the FLA request 514 in a single field of the preamble in accordance with one or more rows of a P matrix, where the one or more rows may correspond to the total quantity of spatial streams associated with the LTFs. Additionally, or alternatively, the FLA request 514 may include a first portion of the LTF associated with a first quantity of spatial streams (such as the first quantity of spatial streams associated with the data portion) in a first field of the preamble and a second portion of the LTF associated with the one or more extra spatial streams in a second field of the preamble.

At 504, in response to receiving the FLA request 514, the wireless device may determine one or more FLA parameter values to include in the FLA feedback 518. For example, the wireless device 550-b may perform one or more measurements associated with the LTFs of the FLA request 514 (such as, associated with a P matrix) to generate a channel matrix, and may determine the one or more FLA parameter values in accordance with the channel matrix. In some examples, the one or more FLA parameter values may include a second quantity of one or more spatial streams (such as an optimal quantity of spatial streams, which may be a quantity of spatial streams associated with a highest communication parameter compared to other possible quantities of spatial streams), which may be a proposed quantity of spatial streams for future communications with the wireless device 550-a. Additionally, or alternatively, the one or more FLA parameter values may include one or more MCS indices associated with the second quantity of one or more spatial streams.

In some examples, the wireless device 550-b may determine the one or more FLA parameter values in accordance with a mapping between spatial streams associated with the FLA request 514 (such as the total quantity of spatial streams associated with the LTFs of the FLA request 514) and a channel matrix (or another matrix, such as a spatial mapping matrix, a P matrix, a precoding matrix, a precoding or spatial mapping matrix for single-user transmit-beamforming scenarios (such as a “V” matrix), an antenna mapping matrix). For example, according to the mapping, the channel matrix may have a nested structure. According to the mapping, a first N spatial streams associated with the LTFs of the FLA request 514 may map to the first N columns of the channel matrix, and the first N spatial streams associated with a data section of a packet (such as of the packet 522) may map to the first N columns of the channel matrix. In other words, for an M×M channel matrix where N<M, N spatial streams for a wireless channel 512 corresponds to a sequentially first (such as left most) and contiguous N columns of the channel matrix. Thus, if the second plurality of spatial streams includes N spatial streams, the N spatial streams and the associated MCS indices may correspond to the sequentially first and contiguous N columns of the channel matrix. Additionally, or alternatively, a similar mapping may apply for beamformed communications. For example, a precoder for the N spatial streams may be the first N eigen vectors of the channel matrix. In some examples, one or more standards documents may specify the mapping.

Additionally, or alternatively, the one or more proposed MCS indices may be associated with one or more columns of a channel matrix in accordance with the mapping. As an example, the mapping may be defined in accordance with the one or more proposed MCS indices being mapped to an equal quantity of sequentially first contiguous columns of the channel matrix (such as, a first MCS index is mapped to a left most column of the channel matrix, a second MCS index is mapped to a second-to-left-most column of the channel matrix, and so on). For example, the second quantity of one or more spatial streams may include one spatial stream, and the one or more proposed MCS indices may include a first MCS index mapped to a sequentially first column of the channel matrix.

In a first example, the wireless device 550-a may transmit the FLA request 514 via a first quantity of spatial streams (such as two spatial streams), and the wireless device 550-b may determine the second quantity of spatial streams (such as the optimal quantity of spatial streams) to be less that the first quantity of spatial streams (such as one spatial stream) according to the generated channel matrix. The wireless device 550-b may calculate the one or more FLA parameter values (such as a CQI, MCS indices, or QAM patterns) to include in the FLA feedback 518 according to the columns of the channel matrix corresponding to the second quantity of spatial streams according to the mapping.

That is, according to the mapping, the wireless device 550-b may calculate at least one of the one or more FLA parameter values (such as the MCS indices) for the second quantity of spatial streams using a quantity of the columns of the channel matrix that is equal to the second quantity of spatial streams. For example, if the second quantity of spatial streams is one spatial stream, the wireless device 550-b may determine the one or more FLA parameter values according to the first (such as, left most) column of the channel matrix. To avoid underuse of one or more antennas in future communications, a spatial mapping matrix for the FLA request 514 (mapped to the spatial streams according to the mapping) may include an orthogonal matrix with non-zero entries (such as without any zero entries). Thus, if the second quantity of spatial streams is less than a total quantity of spatial streams (such as one spatial stream), future communications (such as a packet 522) may utilize each antenna of the transmitting device. For example, the spatial mapping matrix may be an orthogonal Walsh matrix.

In a second example, the wireless device 550-b may transmit the data portion of the FLA request 514 via a first quantity of spatial streams (such as via one spatial stream, Nss) and may transmit the LTFs of the FLA request 514 via more spatial streams than the first quantity of spatial streams (such as via two spatial streams, a total quantity of spatial streams, Nss+Nes). The wireless device 550-b may determine the second quantity of spatial streams (such as the optimal quantity of spatial streams) to be greater than the first quantity of spatial streams according to the channel matrix generated according to the more spatial streams associated with the LTFs. For example, the second quantity of one or more spatial streams may be equal to the total quantity of spatial streams associated with the LTFs of the FLA request 514. The wireless device 550-b may calculate the one or more FLA parameter values (such as a CQI, MCS indices) to include in the FLA feedback 518 according to the columns of the channel matrix corresponding to the second quantity of spatial streams according to the mapping.

At 506, the wireless device 550-a may receive (such as, the wireless device 550-b may transmit), in accordance with the FLA request 514 (such as the request for the proposed FLA parameter values), FLA feedback 518 (such as a second packet) indicating the one or more proposed FLA parameter values (such as those determined at 504). In some examples, the one or more proposed FLA parameter values may be associated with the second quantity of one or more spatial streams in accordance with the mapping of the second quantity of one or more spatial streams to at least a portion of the LTFs of the preamble of the FLA request 514. In some examples, the one or more proposed FLA parameter values may include the one or more proposed MCS indices associated with the second quantity of one or more spatial streams, where the one or more proposed MCS indices may be associated with one or more columns of a channel matrix in accordance with the mapping.

At 508, the wireless device 550-a may determine one or more parameters for communicating with the wireless device 550-b in accordance with the received FLA feedback 518. In some examples, the wireless device 550-a may utilize the proposed FLA parameter values from the FLA feedback 518 to communicate with the wireless device 550-b via the wireless channel 512-c. Additionally, or alternatively, the wireless device 550-a may apply one or more filters to (such as modify) the one or more proposed FLA parameter values of the FLA feedback 518 (such as including the second quantity of spatial streams), and may utilize the filtered FLA parameter values to communicate via the wireless channel 512-c. Additionally, or alternatively, the wireless device 550-a may reject the proposed FLA parameter values (including the second quantity of spatial streams) and utilize different parameters (such as the FLA parameter values used for the FLA request 514) to communicate via the wireless channel 512-c.

At 510, the wireless device 550-a may transmit (such as, the wireless device 550-b may receive) the packet 522 (such as a third packet) in accordance with the one or more proposed FLA parameter values (such as the one or more parameters determined at 508, or modified FLA parameter values as determined at 508). In some examples, the wireless device 550-a may transmit the packet 522 in accordance with an association of the second quantity of one or more spatial streams with an equal quantity of sequentially first contiguous columns in the channel matrix (such as the channel matrix associated with the LTF of the preamble of the FLA request 514, as described with respect to the mapping). For example, the second quantity of one or more spatial streams may include N spatial streams (such as one spatial stream), and the wireless device 550-a may transmit the packet 522 in accordance with a first N columns (such as a left-most column) in the channel matrix.

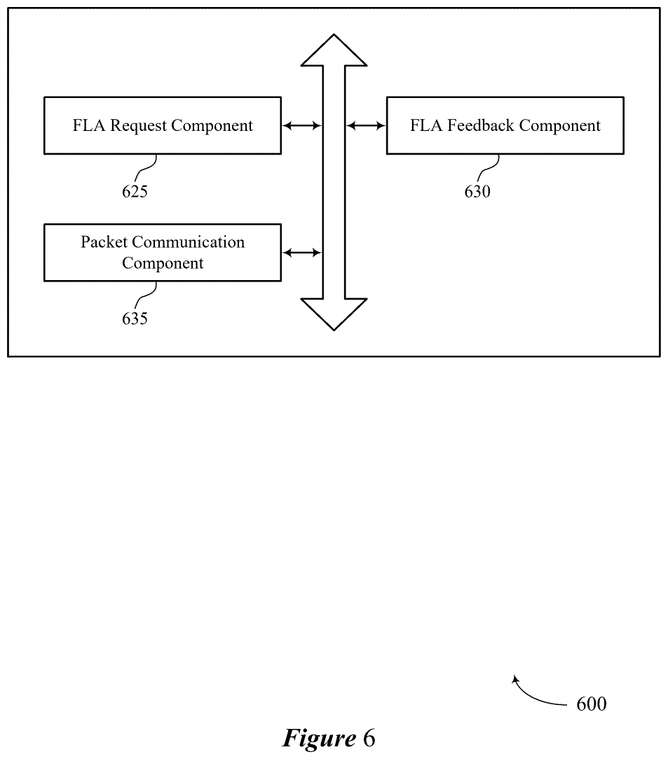

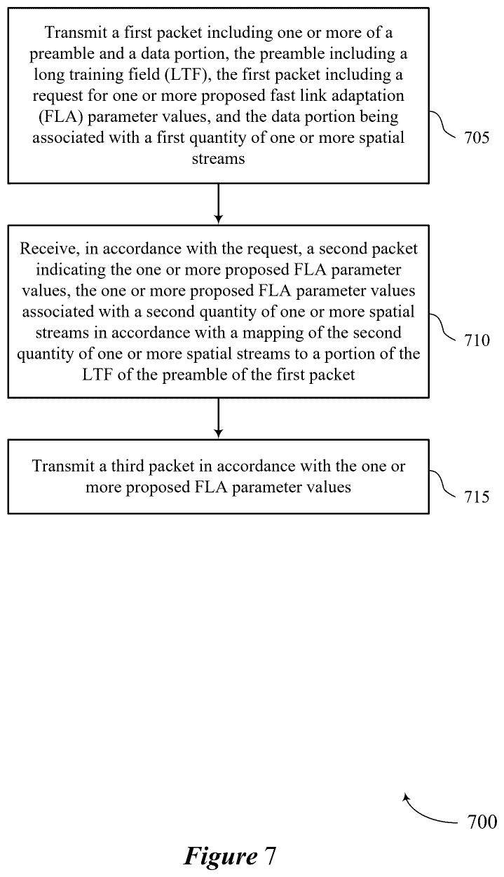

FIG. 6 shows a block diagram of an example wireless communication device 600 that supports multi-stream FLA feedback. In some examples, the wireless communication device 600 is configured to perform the process 700 described with reference to FIG. 7. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an example, the second interface may refer to an interface between the processing system of the chip and a reception component, such that the wireless communication device 600 may receive information that is then passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can be configurable or configured for use in an AP or STA, such as the AP 102 or the STA 104 described with reference to FIG. 1. In some other examples, the wireless communication device 600 can be an AP or STA that includes such a processing system and other components including multiple antennas. The wireless communication device 600 is capable of transmitting and receiving wireless communications in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communications conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes a user interface (UI) (such as a touchscreen or keypad) and a display, which may be integrated with the UI to form a touchscreen display that is coupled with the processing system. In some examples, the wireless communication device 600 may further include one or more sensors such as, for example, one or more inertial sensors, accelerometers, temperature sensors, pressure sensors, or altitude sensors, that are coupled with the processing system. In some examples, the wireless communication device 600 further includes at least one external network interface coupled with the processing system that enables communication with a core network or backhaul network that enables the wireless communication device 600 to gain access to external networks including the Internet.

The wireless communication device 600 includes a FLA request component 625, a FLA feedback component 630, and a packet communication component 635. Portions of one or more of the FLA request component 625, the FLA feedback component 630, and the packet communication component 635 may be implemented at least in part in hardware or firmware. For example, one or more of the FLA request component 625, the FLA feedback component 630, and the packet communication component 635 may be implemented at least in part by at least a processor or a modem. In some examples, portions of one or more of the FLA request component 625, the FLA feedback component 630, and the packet communication component 635 may be implemented at least in part by a processor and software in the form of processor-executable code stored in memory.

The wireless communication device 600 may support wireless communications in accordance with examples as disclosed herein. The FLA request component 625 is configurable or configured to transmit a first packet including one or more of a preamble and a data portion, the preamble including a long training field, the first packet including a request for one or more proposed FLA parameter values, and the data portion being associated with a first quantity of one or more spatial streams. The FLA feedback component 630 is configurable or configured to receive, in accordance with the request, a second packet indicating the one or more proposed FLA parameter values, the one or more proposed FLA parameter values associated with a second quantity of one or more spatial streams in accordance with a mapping of the second quantity of one or more spatial streams to a portion of the LTF of the preamble of the first packet. The packet communication component 635 is configurable or configured to transmit a third packet in accordance with the one or more proposed FLA parameter values.

In some examples, a total quantity of spatial streams associated with the LTF is greater than the first quantity of one or more spatial streams.

In some examples, to support transmitting the first packet, the FLA request component 625 is configurable or configured to transmit an indication of one or more extra spatial streams associated with the LTF of the preamble of the first packet, where the one or more extra spatial streams include spatial streams associated with the LTF that are in excess of the first quantity of one or more spatial streams.

In some examples, the LTF is transmitted in a single field of the preamble in accordance with one or more rows of a P matrix, the one or more rows corresponding to the total quantity of spatial streams associated with the LTF.

In some examples, to support transmitting the first packet, the FLA request component 625 is configurable or configured to transmit a first portion of the LTF associated with the first quantity of spatial streams in a first field of the preamble and a second portion of the LTF associated with the one or more extra spatial streams in a second field of the preamble.

In some examples, the total quantity of spatial streams associated with the LTF is equal to the second quantity of one or more spatial streams.

In some examples, to support receiving the one or more proposed FLA parameter values, the FLA feedback component 630 is configurable or configured to receive one or more proposed MCS indices associated with the second quantity of one or more spatial streams, where the one or more proposed MCS indices are associated with one or more columns of a channel matrix in accordance with the mapping of the second quantity of one or more spatial streams to the portion of the LTF.

In some examples, the mapping of the second quantity of one or more spatial streams to the portion of the LTF is defined in accordance with the one or more proposed MCS indices being mapped to an equal quantity of sequentially first contiguous columns of the channel matrix.

In some examples, the second quantity of one or more spatial streams includes one spatial stream, and the one or more proposed MCS indices include a first MCS index mapped to a sequentially first column of the channel matrix.

In some examples, the third packet is transmitted in accordance with an association of the second quantity of one or more spatial streams with an equal quantity of sequentially first contiguous columns in a channel matrix associated with the LTF of the preamble of the first packet.

In some examples, the second quantity of one or more spatial streams includes one spatial stream, and the third packet is transmitted in accordance with a first column in the channel matrix associated with the LTF of the preamble of the first packet.

FIG. 7 shows a flowchart illustrating an example process 700 performable by or at a wireless device that supports multi-stream FLA feedback. The operations of the process 700 may be implemented by a wireless device or its components as described herein. For example, the process 700 may be performed by a wireless communication device, such as the wireless communication device 600 described with reference to FIG. 6, operating as or within a wireless AP or a wireless STA. In some examples, the process 700 may be performed by a wireless AP or a wireless STA, such as one of the APs 102 or the STAs 104 described with reference to FIG. 1.

In some examples, in 705, the wireless device may transmit a first packet including one or more of a preamble and a data portion, the preamble including a long training field, the first packet including a request for one or more proposed FLA parameter values, and the data portion being associated with a first quantity of one or more spatial streams. The operations of 705 may be performed in accordance with examples as disclosed herein. In some implementations, aspects of the operations of 705 may be performed by a FLA request component 625 as described with reference to FIG. 6.

In some examples, in 710, the wireless device may receive, in accordance with the request, a second packet indicating the one or more proposed FLA parameter values, the one or more proposed FLA parameter values associated with a second quantity of one or more spatial streams in accordance with a mapping of the second quantity of one or more spatial streams to a portion of the LTF of the preamble of the first packet. The operations of 710 may be performed in accordance with examples as disclosed herein. In some implementations, aspects of the operations of 710 may be performed by a FLA feedback component 630 as described with reference to FIG. 6.

In some examples, in 715, the wireless device may transmit a third packet in accordance with the one or more proposed FLA parameter values. The operations of 715 may be performed in accordance with examples as disclosed herein. In some implementations, aspects of the operations of 715 may be performed by a packet communication component 635 as described with reference to FIG. 6.

Implementation examples are described in the following numbered clauses:

Aspect 1: A method for wireless communications at a wireless device, comprising: transmitting a first packet including one or more of a preamble and a data portion, the preamble including a LTF, the first packet including a request for one or more proposed FLA parameter values, and the data portion being associated with a first quantity of one or more spatial streams; receiving, in accordance with the request, a second packet indicating the one or more proposed FLA parameter values, the one or more proposed FLA parameter values associated with a second quantity of one or more spatial streams in accordance with a mapping of the second quantity of one or more spatial streams to a portion of the LTF of the preamble of the first packet; and transmitting a third packet in accordance with the one or more proposed FLA parameter values.

Aspect 2: The method of aspect 1, wherein a total quantity of spatial streams associated with the LTF is greater than the first quantity of one or more spatial streams.

Aspect 3: The method of aspect 2, wherein transmitting the first packet comprises: transmitting an indication of one or more extra spatial streams associated with the LTF of the preamble of the first packet, wherein the one or more extra spatial streams include spatial streams associated with the LTF that are in excess of the first quantity of one or more spatial streams.

Aspect 4: The method of aspect 3, wherein the LTF is transmitted in a single field of the preamble in accordance with one or more rows of a P matrix, the one or more rows corresponding to the total quantity of spatial streams associated with the LTF.

Aspect 5: The method of aspect 3, wherein transmitting the first packet further comprises: transmitting a first portion of the LTF associated with the first quantity of spatial streams in a first field of the preamble and a second portion of the LTF associated with the one or more extra spatial streams in a second field of the preamble.

Aspect 6: The method of any of aspects 2 through 5, wherein the total quantity of spatial streams associated with the LTF is equal to the second quantity of one or more spatial streams.

Aspect 7: The method of any of aspects 1 through 6, wherein receiving the one or more proposed FLA parameter values comprises: receiving one or more proposed MCS indices associated with the second quantity of one or more spatial streams, wherein the one or more proposed MCS indices are associated with one or more columns of a channel matrix in accordance with the mapping of the second quantity of one or more spatial streams to the portion of the LTF.

Aspect 8: The method of aspect 7, wherein the mapping of the second quantity of one or more spatial streams to the portion of the LTF is defined in accordance with the one or more proposed MCS indices being mapped to an equal quantity of sequentially first contiguous columns of the channel matrix.

Aspect 9: The method of aspect 8, wherein the second quantity of one or more spatial streams includes one spatial stream, and the one or more proposed MCS indices include a first MCS index mapped to a sequentially first column of the channel matrix.

Aspect 10: The method of any of aspects 1 through 9, wherein the third packet is transmitted in accordance with an association of the second quantity of one or more spatial streams with an equal quantity of sequentially first contiguous columns in a channel matrix associated with the LTF of the preamble of the first packet.

Aspect 11: The method of aspect 10, wherein the second quantity of one or more spatial streams includes one spatial stream, and the third packet is transmitted in accordance with a first column in the channel matrix associated with the LTF of the preamble of the first packet.

Aspect 12: A wireless device for wireless communications, comprising a processing system that includes processor circuitry and memory circuitry that stores code, the processing system configured to cause the wireless device to perform a method of any of aspects 1 through 11.

Aspect 13: A wireless device for wireless communications, comprising at least one means for performing a method of any of aspects 1 through 11.

Aspect 14: A non-transitory computer-readable medium storing code for wireless communications, the code comprising instructions executable by one or more processors to perform a method of any of aspects 1 through 11.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A wireless device, comprising:
a processing system that includes processor circuitry and memory circuitry that stores code, the processing system configured to cause the wireless device to:
transmit a first packet including one or more of a preamble and a data portion, the preamble including a long training field (LTF) associated with a channel matrix, the first packet including a request for one or more proposed fast link adaptation (FLA) parameter values, the data portion being associated with a first quantity of one or more spatial streams, and the channel matrix comprising an orthogonal matrix specifying FLA parameter values according to quantities of spatial streams, the quantities of spatial streams including at least the first quantity of one or more spatial streams;
receive, in accordance with the request, a second packet indicating the one or more proposed FLA parameter values of the FLA parameter values, the one or more proposed FLA parameter values associated with a second quantity of one or more spatial streams of the LTF of the preamble of the first packet; and
transmit a third packet in accordance with the one or more proposed FLA parameter values and in accordance with a mapping of the second quantity of one or more spatial streams to an equal quantity of sequentially first contiguous columns in the channel matrix associated with the LTF of the preamble of the first packet.

2. The wireless device of claim 1, wherein a total quantity of spatial streams associated with the LTF is greater than the first quantity of one or more spatial streams and wherein the quantities of spatial streams of the channel matrix includes the total quantity of spatial streams.

3. The wireless device of claim 2, wherein, to transmit the first packet, the processing system is configured to cause the wireless device to:
transmit an indication of one or more extra spatial streams associated with the LTF of the preamble of the first packet, wherein the one or more extra spatial streams include spatial streams associated with the LTF that are in excess of the first quantity of one or more spatial streams.

4. The wireless device of claim 3, wherein the LTF is transmitted in a single field of the preamble in accordance with one or more rows of a pilot matrix, the one or more rows corresponding to the total quantity of spatial streams associated with the LTF.

5. The wireless device of claim 3, wherein, to transmit the first packet, the processing system is further configured to cause the wireless device to:
transmit a first portion of the LTF associated with the first quantity of spatial streams in a first field of the preamble and a second portion of the LTF associated with the one or more extra spatial streams in a second field of the preamble.

6. The wireless device of claim 2, wherein the total quantity of spatial streams associated with the LTF is equal to the second quantity of one or more spatial streams.

7. The wireless device of claim 1, wherein, to receive the one or more proposed FLA parameter values, the processing system is configured to cause the wireless device to:
receive one or more proposed modulation and coding scheme (MCS) indices associated with the second quantity of one or more spatial streams, wherein the one or more proposed MCS indices are associated with one or more columns of the channel matrix in accordance with the mapping of the second quantity of one or more spatial streams to the portion of the LTF.

8. The wireless device of claim 7, wherein the mapping of the second quantity of one or more spatial streams to the portion of the LTF is defined in accordance with the one or more proposed MCS indices being mapped to an equal quantity of sequentially first contiguous columns of the channel matrix.

9. The wireless device of claim 8, wherein the second quantity of one or more spatial streams includes one spatial stream, and the one or more proposed MCS indices include a first MCS index mapped to a sequentially first column of the channel matrix.

10. (canceled)

11. A method for wireless communications at a wireless device, comprising:
transmitting a first packet including one or more of a preamble and a data portion, the preamble including a long training field (LTF) associated with a channel matrix, the first packet including a request for one or more proposed fast link adaptation (FLA) parameter values, the data portion being associated with a first quantity of one or more spatial streams, and the channel matrix comprising an orthogonal matrix specifying FLA parameter values according to quantities of spatial streams, the quantities of spatial streams including at least the first quantity of one or more spatial streams;
receiving, in accordance with the request, a second packet indicating the one or more proposed FLA parameter values of the FLA parameter values, the one or more proposed FLA parameter values associated with a second quantity of one or more spatial streams of the LTF of the preamble of the first packet; and
transmitting a third packet in accordance with the one or more proposed FLA parameter values and in accordance with a mapping of the second quantity of one or more spatial streams to an equal quantity of sequentially first contiguous columns in the channel matrix associated with the LTF of the preamble of the first packet.

12. The method of claim 11, wherein a total quantity of spatial streams associated with the LTF is greater than the first quantity of one or more spatial streams and wherein the quantities of spatial streams of the channel matrix includes the total quantity of spatial streams.

13. The method of claim 12, wherein transmitting the first packet comprises:
transmitting an indication of one or more extra spatial streams associated with the LTF of the preamble of the first packet, wherein the one or more extra spatial streams include spatial streams associated with the LTF that are in excess of the first quantity of one or more spatial streams.

14. The method of claim 13, wherein the LTF is transmitted in a single field of the preamble in accordance with one or more rows of a pilot matrix, the one or more rows corresponding to the total quantity of spatial streams associated with the LTF.

15. The method of claim 13, wherein transmitting the first packet further comprises:
transmitting a first portion of the LTF associated with the first quantity of spatial streams in a first field of the preamble and a second portion of the LTF associated with the one or more extra spatial streams in a second field of the preamble.

16. The method of claim 12, wherein the total quantity of spatial streams associated with the LTF is equal to the second quantity of one or more spatial streams.

17. The method of claim 11, wherein receiving the one or more proposed FLA parameter values comprises:
receiving one or more proposed modulation and coding scheme (MCS) indices associated with the second quantity of one or more spatial streams, wherein the one or more proposed MCS indices are associated with one or more columns of the channel matrix in accordance with the mapping of the second quantity of one or more spatial streams to the portion of the LTF.

18. The method of claim 17, wherein the mapping of the second quantity of one or more spatial streams to the portion of the LTF is defined in accordance with the one or more proposed MCS indices being mapped to an equal quantity of sequentially first contiguous columns of the channel matrix.

19. (canceled)

20. The method of claim 11, wherein the second quantity of one or more spatial streams includes one spatial stream, and the third packet is transmitted in accordance with a first column in the channel matrix associated with the LTF of the preamble of the first packet.

21. The method of claim 18, wherein the second quantity of one or more spatial streams includes one spatial stream, and the one or more proposed MCS indices include a first MCS index mapped to a sequentially first column of the channel matrix.

22. The wireless device of claim 1, wherein the second quantity of one or more spatial streams includes one spatial stream, and the third packet is transmitted in accordance with a first column in the channel matrix associated with the LTF of the preamble of the first packet.
